(19) United States
(12) Patent Application Publication
(10) Pub. No.: US 2020/0042908 A1
(43) Pub. Date: Feb. 6, 2020

(54) COMMON RISK MITIGATION MECHANISM (CRMM) FOR SOLAR PHOTOVOLTAIC (PV) POWER PLANT CONSTRUCTION

(71) Applicant: Terrawatt Initiative, Paris (FR)

(72) Inventors: Germain Hurtado, Issy les Moulineaux (FR); Sebastien Manganneau, Fontenay sous bois (FR); Weston Moran, Merrimack, NH (US); Jean-Pascal Pham Ba, Issy les Moulineaux (FR); Lila Tretikov, Paris (FR)

(21) Appl. No.: 16/054,322

(22) Filed: Aug. 3, 2018

(51) Int. Cl. G06Q 10/06; G06Q 40/04; G06Q 40/06; G06Q 50/18; G06Q 40/08

(52) U.S. Cl. CPC G06Q 10/06; G06Q 40/04; G06Q 40/08; G06Q 50/188; G06Q 40/06

(57) ABSTRACT

A method for managing digital tokens in the CRMM includes receiving both data pertaining to a tender offer by a purchasing entity for an infrastructure project such as a solar PV project, and also data pertaining to a guarantee of required financing for the tender offer including an estimate of a premium for the guarantee and one or more compliance terms for the guarantee. The method additionally includes combining the data pertaining to the tender offer with the data pertaining to the guarantee into a single cryptographically encrypted digital token and transmitting the token to the purchasing entity. Finally, the method includes subsequently periodically receiving requests to validate the token from different prospective participants in the project and upon confirming an authenticity of the token, replying to each of the requests with an indication of validation.

### BACKGROUND OF THE INVENTION

### Field of the Invention

The present invention relates to the field of infrastructure financing and more particularly to risk mitigation in solar PV project management.

### Description of the Related Art

In the developed world, power generation as the counterpart to power utilization is a presumptive aspect of daily life both private and commercial as the accessibility to adequate power, no matter the purpose, is assumed by all. Indeed, the vast majority of those living and working in the developed world not only presume access to power, but in most cases are unaware of the source of the power, be it a traditional thermal power source such as nuclear, coal or natural gas, or a renewable source such as wind, water or solar PV. But, in the developing world, access to power hardly can be viewed as presumptive. In fact, in many regions of the developing world there remains a dearth of electrical power generation. The economic and social cost of a lagging power infrastructure has been quantified in the billions of dollars.

Whereas the obvious solution to the lagging power infrastructure of underdeveloped or developing regions of the world clearly is the simple construction of new power generation facilities, so much has proven to be a complex consideration. For one, selecting a type of power generation facility must include consideration for parallel global concerns including climate change. As such, renewable energy sources such as wind, water and solar PV often are preferred to more traditional thermal sources of power—especially those reliant upon hydrocarbons as fuel. As well, given the massive cost of construction of a single power generation facility, acquiring reliable financing for the construction of the single power generation facility is no small feat. To compound matters, whereas private investment capital coupled with some governmental support is common in more developed regions of the world, the risk associated with the construction and operation of a power generation facility in parts of the developing world can act as a barrier to the requisite financing in bringing a new power generation plant to life.

In this regard, traditionally the construction of power generation facilities is financed according to one of two methodologies: by way of public and utility financing or by way of independent power project (IPP). In either circumstance, the risk associated with financing the construction of the power generation facility, operating the power generation facility once commissioned, and also in receiving promised returns through a pre-negotiated power purchase agreement (PPA) act as a consideration by lenders in financing the construction and also by the contractors required to construct the power generation facility. As well, the cost of the necessary capital is directly influenced by the degree of perceived risk. In both instances, for the developing world of mid-income and low-income countries, the risks of currency exchange, transfers and inconvertibility, electricity purchasing counterparties and political instability combine to render the construction of new power generation facilities—especially solar PV projects—unlikely.

Much of the perceived risk in the proposed financing of a new power generation plant derives from insufficient information sharing. Each participant in a power generation project are subjected to a high degree of information asymmetries and consequentially a high level of uncertainty. This dynamic prevents a large number of participants from even considering the possibility of entering the marketspace of new power generation plant construction. Thus, competition for each role played by each participant is greatly reduced adversely impacting market activity and resulting in a substantially higher cost of construction and ultimately, operation. The impact of this dynamic is even stronger on small-scale decentralized infrastructures such as solar power generation assets in low-income and middle-income countries.

### BRIEF SUMMARY OF THE INVENTION

Embodiments of the present invention address deficiencies of the art in respect to information sharing in infrastructure project financing including the financing of a power generation project, and provide a novel and non-obvious method, system and computer program product for a common risk mitigation mechanism (CRMM) for infrastructure project financing and construction. In one embodiment of the invention, a method for managing digital tokens in the CRMM is provided. The method includes receiving from over a computer communications network in memory of a host computing system, both data pertaining to a tender offer by a purchasing entity for an infrastructure project, and also data pertaining to a guarantee of required financing for the tender offer including an estimate of a premium for the guarantee, one or more compliance terms for the guarantee and one or more operational parameters of the infrastructure project. The method additionally includes combining the data pertaining to the tender offer with the data pertaining to the guarantee into a single cryptographically encrypted digital token that has been adapted for decryption with a corresponding decryption key, and encapsulating information necessary for creation, management, finance, insurance and securitization of one or more infrastructure assets of the infrastructure project, and transmitting the token to the purchasing entity over the computer communications network. Finally, the method includes subsequently periodically receiving from over the computer communications network, requests to validate the single digital token from different prospective participants in the project and upon confirming an authenticity of the token, replying to each of the requests over the computer communications network with an indication of validation.

In one aspect of the embodiment, the infrastructure project is a solar PV project and may be modeled as a project object in memory of the host computing system to include a single developer, an estimated capacity of power generation, a distance to a nearest power grid, a contemporaneous state of a workflow for the solar PV project and a projected risk premium supplied by the single digital token. As such, the project object may be stored in a database in fixed storage coupled to the host computing system and the method may include responding to queries on the database from actual participants in the solar PV project by returning data in the project object for the solar PV project to the requesting actual participants over the computer communications network. In another aspect of the embodiment, a developer object in the database may be associated with the project object and at least one other project object also stored in the database. In yet another aspect of the embodiment, a risk portfolio object in the database may be associated with the project object and at least one other project object also stored in the database, and a risk score value and a risk premium aggregating project risk premium data from each project object associated with the risk portfolio object each may be stored in the risk portfolio object.

In another embodiment of the invention, a data processing system is configured to support a CRMM. The system includes a host computing system of one or more computers, each with memory and at least one processor. The system also includes a database storing different data objects confirming to a data model modeling an eco-system of infrastructure projects, including power generation projects such as solar PV projects. The system yet further includes a Web server executing in the host computing system and serving in response to requests from prospective and actual participants to one or more of the projects, information stored in the different data objects. Finally, the system includes a CRMM module. The CRMM module includes program code executing in the memory of the host computing system so as to perform a method of managing digital tokens in the CRMM.

The method includes receiving from over a computer communications network in the memory of the host computing system, both data pertaining to a tender offer by a purchasing entity for a project, and also data pertaining to a guarantee of required financing for the tender offer including an estimate of a premium for the guarantee, one or more compliance terms for the guarantee and one or more operational parameters of the infrastructure project. The method additionally includes combining the data pertaining to the tender offer with the data pertaining to the guarantee into a single cryptographically encrypted digital token that has been adapted for decryption with a corresponding decryption key, and which encapsulates information necessary for creation, management, finance, insurance and securitization of one or more infrastructure assets of the infrastructure project, and transmitting the token to the purchasing entity over the computer communications network. Finally, the method includes subsequently periodically receiving from over the computer communications network, requests to validate the token from different prospective participants in the project and upon confirming an authenticity of the token, replying to each of the requests over the computer communications network with an indication of validation.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of an eco-system for solar PV plant financing and construction implementing a CRMM;

FIG. 2 is an architecture diagram depicting an architecture incorporating the CRMM for the eco-system of FIG. 1;

FIG. 3 is a schematic illustration of a data processing system configured to support the CRMM of FIG. 2;

FIG. 4 is a relationship diagram illustrating a data model of the data processing system of FIG. 3; and,

FIG. 5 is a pictorial illustration of a process for managing digital tokens in the CRMM of FIG. 3.

### DETAILED DESCRIPTION OF THE INVENTION

Embodiments of the invention provide for a CRMM for infrastructure project financing and construction. In accordance with an embodiment of the invention, a purchasing entity transmits to the CRMM acting on behalf of a guarantor, information pertaining to a prospective project. The information includes tender data such as the underlying terms and conditions upon which the solar PV project is to be constructed and operated. Upon acceptance by the guarantor, the CRMM encodes into a single, cryptographically encrypted digital token, the information along with an estimate of a guarantor premium payment and one or more compliance conditions for each developer agreeing to participate in the prospective project. The CRMM then returns the digital token to the purchasing entity. Thereafter, the purchasing entity may publish to one or more prospective participants to the project, a tender consistent with the tender data along with the token. Each recipient of the tender may then query the CRMM with the token to confirm the authenticity of the token and also each recipient of the token may extract the tender data and the compliance data and the estimated premium payment from the token in order to assess the desirability of the tender or investing in the project. In this way, transparency of information with respect to the project is assured throughout the lifespan of the project.

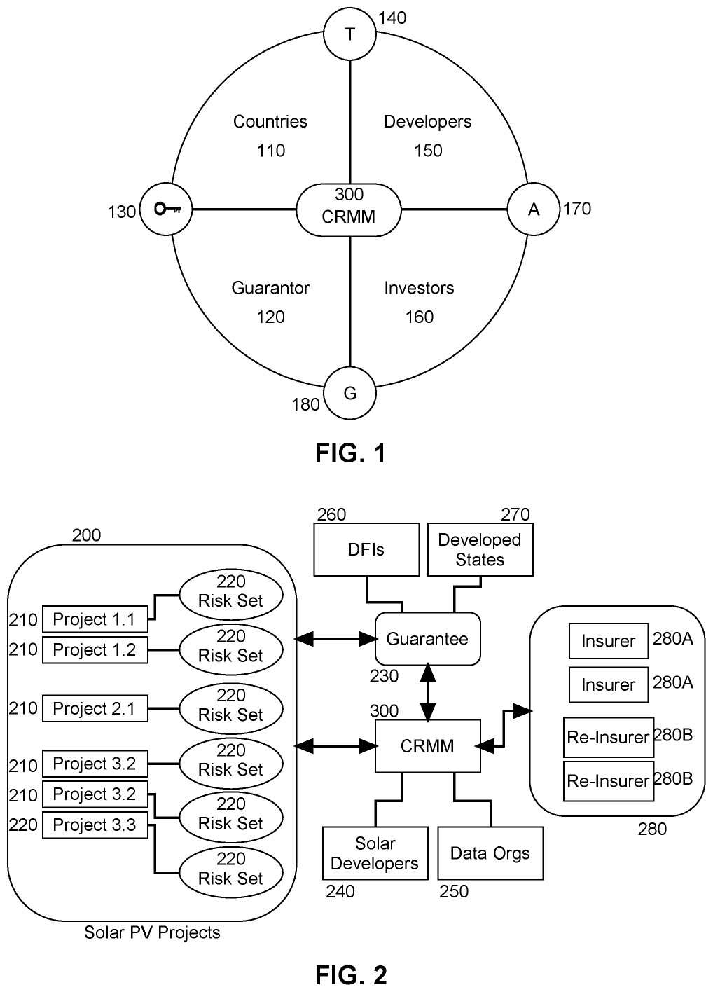

In further illustration, FIG. 1 is pictorial illustration of an eco-system for infrastructure project financing and construction implementing a CRMM. As shown in FIG. 1, an eco-system for the financing and construction of an infrastructure project, by way of example, a solar PV plant, includes different purchasing entities 110, for example one or more governmental entities, seeking the construction of corresponding solar PV plants, different guarantors 120 of debt financing of the construction of the solar PV plants, different investors 160 supplying the debt financing, and developers 150 constructing the solar PV plants utilizing the debt financing to do so. The CRMM provides a transparent, reliable common platform to coordinate the interactions of the ecosystem.

Specifically, each of the purchasing entities 110 begins with the formulation of tender data describing the terms and risks upon which a solar PV plant is to be constructed within the geographical bounds of the corresponding one of the governmental entities 110. The tender data is then provided to the CRMM 300 for presentation to the guarantor 120. The guarantor 120 assesses the risk of the prospective solar PV plant according to the tender data and computes a risk premium and one or more constraints of guaranteeing a debt obligation in furtherance of the construction of the solar PV plant. The CRMM 300 then packages the tender data, the risk premium and constraints into a single digital token 130 which is returned to the corresponding one of the governmental entities 110.

The corresponding one of the purchasing entities 110 then formulates a tender 140 incorporating the tender data and including the digital token 130. The corresponding one of the purchasing entities 110 then provides the tender 140 along with the digital token 130 to one or more developers 150 for bidding. The developers 150 each are able to validate the data of the tender 140 and especially the risk premium encapsulated therein by submitting the digital token 130 to the CRMM 300. Financing is achieved for the solar PV plant by investors 160, each of whom may validate the nature of the proposed project utilizing the digital token 130. The investors 160 then provide an aggregated investment 170 supporting the construction of the solar PV plant guaranteed by a guarantee 180 provided by the guarantor 120. In this way, the lifecycle of the construction of the solar PV plant is managed in a transparent manner facilitated by common access to risk information supplied by the digital token 130 and managed by the CRMM 300.

The eco-system illustrated in FIG. 1 may be implemented according to a data processing architecture. In further illustration, FIG. 2 is an architecture diagram depicting an architecture incorporating the CRMM for the eco-system of FIG. 1. The architecture includes as its central feature, the CRMM 300. The CRMM 300 is a software service that creates and distributes digital tokens in connection with different infrastructure projects 200, by way of example solar PV projects, including tender data 210 and risk set data 220. The digital tokens incorporate risk premium information and constraints in support of a guarantee 230 provided by different development finance institutions (DFIs) and directly by developed states 270, and insured by a pool of insurance entities 280 including both primary insurers 280A and secondary re-insurers 280B.

Each participant in the pool of insurance entities 280 may validate the tender data 210 and the risk set 220 of a corresponding one of the solar PV projects 200 by query to the CRMM 300 and by validation and inspection of a corresponding digital token generated by the CRMM 300. As well, developers 240 seeking to contract in furtherance of the construction of a corresponding one of the solar PV projects 200 may validate the tender data 210 and the risk set 220 of a corresponding one of the solar PV projects 200 by query to the CRMM 300 and by validation and inspection of a corresponding digital token generated by the CRMM 300. Finally, the CRMM 300 is able to draw on data from different data organizations 250 in order to more accurately present predicted risk premiums for respectively different risk sets 220 of prospective ones of the solar PV projects 200 based upon known outcomes of completed ones of the solar PV projects 200.

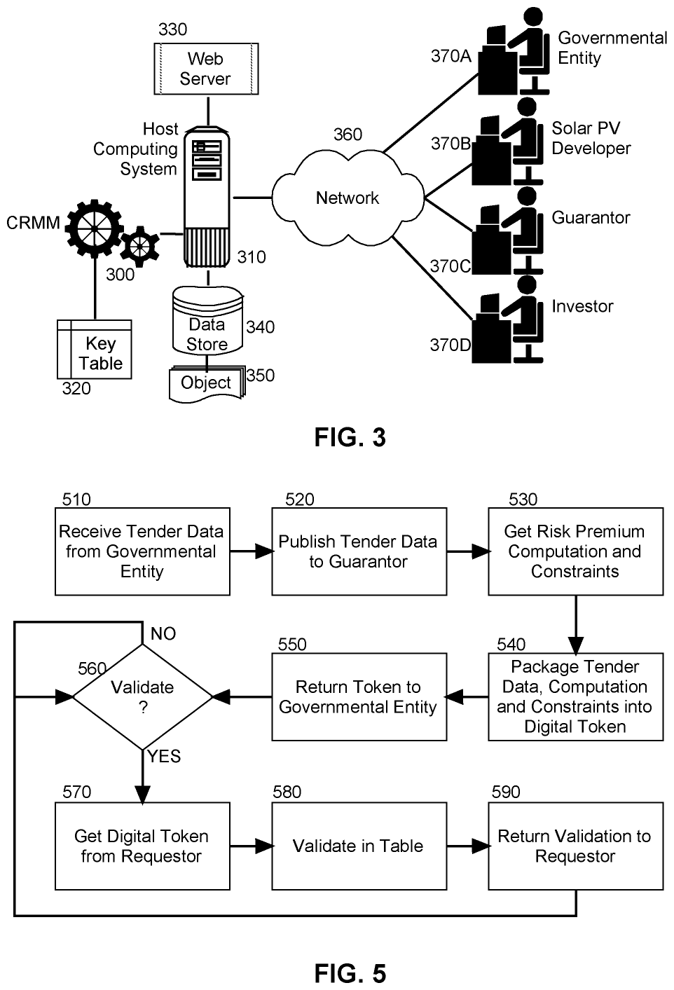

The architecture of FIG. 2 may be implemented within a data processing system. In yet further illustration, FIG. 3 is a schematic illustration of a data processing system configured to support the CRMM of FIG. 2. The system includes a host computing system 310 of one or more computers, each with memory and at least one processor. The host computing system 310 is communicatively coupled to different computing clients 370A, 370B, 370C, 370D over computer communications network 360 and supports the operation of a Web server 330 adapted to respond to queries from the different computing clients 370A, 370B, 370C, 370D with data encapsulated in different data objects 350 disposed within a data store 340.

The CRMM 300 is a program module providing a software service accessible over the computer communications network 360. The CRMM 300 includes program instructions adapted to respond to the receipt of tender data for a solar PV project from client 370A on behalf of a governmental entity by acquiring risk premium data and imposed constraints from over the computer communications network 360 from client 370C on behalf of a guarantor. The program instructions are additionally adapted to encode the tender data, the risk premium data and the constraints in a digital token and to return the digital token over the computer communications network 360 to the client 370A.

The client 370A on behalf of the governmental entity may then publish along with the digital token, a tender to clients 370B, 370D seeking both solar PV developer and investor participants in the solar PV project. Each of the participants through clients 370B, 370D may submit the digital token received from the client 370A to the CRMM 300 in order to validate the digital token in respect to an entry key table 320. In this way, the data pertaining to the tender offer and the computed risk by the guarantor remain transparent and consistent throughout the process of financing the solar PV project. As well, data pertaining to all solar PV projects may be stored as an arrangement of data objects 350 disposed in the data store 340 in accordance with a corresponding data model of the CRMM 300.

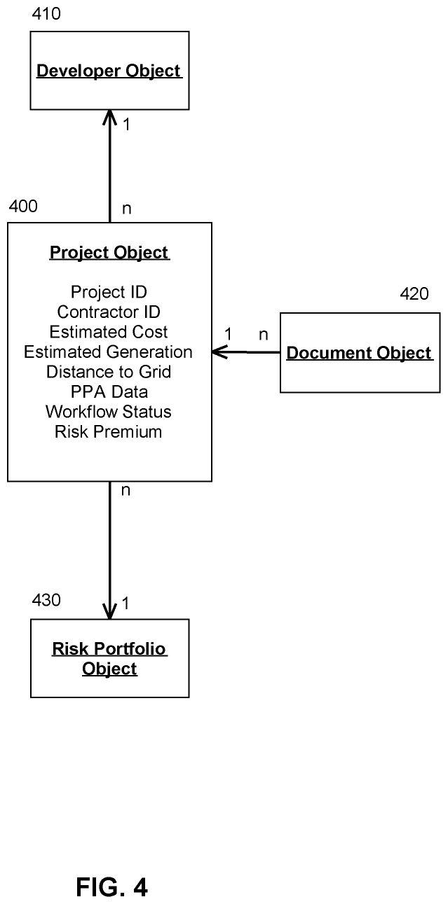

In even yet further illustration, FIG. 4 is a relationship diagram illustrating a data model of the data processing system of FIG. 3. As shown in FIG. 4, each solar PV project is modeled as an object instance of a project 400 that specifies a project identifier, an identifier of a contractor contractually bound to the solar PV project and an estimated cost of construction. The object instance of the project 400 also includes data members pertaining to the estimated generation of power once the solar PV project is completed and online, a distance of the solar PV project to the existing power grid, and data pertaining to an in-place PPA for the solar PV project. Finally, the object instance of the project encapsulates data members for a status in the workflow of constructing the solar PV project and a risk premium assessed for the solar PV project by a corresponding guarantor.

Of note, an instance of a developer object 410 for a corresponding developer may be associated with a multiplicity of instances of the project object 400 so that by querying on a particular developer identifier, the querying party may discover all solar PV projects to which the developer has been contracted. Likewise, an instance of a risk portfolio object 430 may be created in association with a multiplicity of instances of project objects 400 so as to reflect a bundling of risk for multiple solar PV projects. Finally, it bears noting that each instance of the project object 400 may be associated with one or more document object instances 420 reflecting template standard documentation utilized in the course of financing and constructing a corresponding solar PV project.

In even yet further illustration of the operation of the CRMM 300 of FIG. 3, FIG. 5 is a pictorial illustration of a process for managing digital tokens in the CRMM of FIG. 3. Beginning in block 510, the CRMM receives tender data from governmental entity. In block 520, the tender data is published to one or more guarantors who in return in block 530 provide to the CRMM both a risk premium computation for the solar PV project associated with the tender data, and also one or more constraints imposed as a condition of a guarantee issued by the guarantor in furtherance of the construction of the solar PV project. In block 540, the tender data, risk premium computation and constraints are packaged into a digital token which is returned to the governmental entity by the CRMM in block 550.

In decision block 560, it is determined whether or not a digital token subsequently received from a contractor or investor is valid. If so, in block 570 the digital token is retrieved from the requestor and in block 580 the digital token is validated based upon a record in a corresponding key table. To the extent the digital token is located in the table, in block 590 an indication of validation is returned to the requestor so as to confirm the authenticity of the tender data, risk premium computation and constraints contained within the digital token. In this way, each participant to the financing process maintains transparent and accurate access to risk information pertaining to the solar PV project.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for managing digital tokens in the common risk management mechanism (CRMM) comprising:
receiving from over a computer communications network in memory of a host computing system, data pertaining to a tender offer by a purchasing entity for an infrastructure project;
additionally receiving from over the computer communication network in the memory of the host computing system, data pertaining to a guarantee of required financing for the tender offer including an estimate of a premium for the guarantee, one or more compliance terms for the guarantee and one or more operational parameters of the infrastructure project;
combining the data pertaining to the tender offer with the data pertaining to the guarantee into a single cryptographically encrypted digital token, adapted for decryption with a corresponding decryption key, the token thereby encapsulating information necessary for creation, management, finance, insurance and securitization of one or more infrastructure assets of the infrastructure project;
transmitting the single digital token to the purchasing entity over the computer communications network; and,
subsequently periodically receiving from over the computer communications network, requests to validate the single cryptographically encrypted digital token from different prospective participants in the infrastructure project and upon confirming an authenticity of the signal cryptographically encrypted digital token, replying to each of the requests over the computer communications network with an indication of validation.

2. The method of claim 1, wherein the infrastructure project is a solar photovoltaic (PV) project, the method further comprising:
modeling the solar PV project as a project object in memory of the host computing system to include a single developer, an estimated capacity of power generation, a distance to a nearest power grid, a contemporaneous state of a workflow for the solar PV project and a projected risk premium supplied by the single digital token;
storing the project object in a database in fixed storage coupled to the host computing system; and,
responding to queries on the database from actual participants in the solar PV project by returning data in the project object for the solar PV project to the requesting actual participants over the computer communications network.

3. The method of claim 2, further comprising, associating a developer object in the database with the project object and at least one other project object also stored in the database.

4. The method of claim 2, further comprising associating a risk portfolio object in the database with the project object and at least one other project object also stored in the database and storing in the risk portfolio object, a risk score value and a risk premium aggregating project risk premium data from each project object associated with the risk portfolio object.

5. The method of claim 1, further comprising:
receiving from one of the different prospective participants in the infrastructure project, additional information pertaining to implementation of the infrastructure project by the one of the different prospective participants; and,
adding the additional information to the token.

6. The method of claim 1, further comprising:
loading from the fixed storage, multiple different project objects for correspondingly different infrastructure projects;
identifying amongst the different project objects, common infrastructure assets with similar characteristics;
performing an analytical operation on each of the common infrastructure assets to produce at least one metric pertinent to all of the common infrastructure assets; and,
writing the metric to each of the project objects.

7. A data processing system configured to support a common risk mitigation mechanism (CRMM), the system comprising:
a host computing system of one or more computers, each with memory and at least one processor;
a database storing different data objects confirming to a data model modeling an eco-system of infrastructure projects;
a Web server executing in the host computing system and serving in response to requests from prospective and actual participants to one or more of the infrastructure projects, information stored in the different data objects; and,
a CRMM module comprising program code executing in the memory of the host computing system and performing:
receiving from over a computer communications network in the memory of the host computing system, data pertaining to a tender offer by a purchasing entity for one of the infrastructure projects;
additionally receiving from over the computer communication network in the memory of the host computing system, data pertaining to a guarantee of required financing for the tender offer including an estimate of a premium for the guarantee, one or more compliance terms for the guarantee and one or more operational parameters of the infrastructure project;
combining the data pertaining to the tender offer with the data pertaining to the guarantee into a single cryptographically encrypted digital token, adapted for decryption with a corresponding decryption key, the token thereby encapsulating information necessary for creation, management, finance, insurance and securitization of one or more infrastructure assets of the infrastructure project;
transmitting the single digital token to the purchasing entity over the computer communications network; and,
subsequently periodically receiving from over the computer communications network, requests to validate the single cryptographically encrypted digital token from different prospective participants in the one of the infrastructure projects and upon confirming an authenticity of the signal cryptographically encrypted digital token, replying to each of the requests over the computer communications network with an indication of validation.

8. The system of claim 7, wherein the one of the infrastructure projects is a solar photovoltaic (PV) project, and wherein the program code is further enabled to perform:
modeling the solar PV project as a project object in memory of the host computing system to include a single developer, an estimated capacity of power generation, a distance to a nearest power grid, a contemporaneous state of a workflow for the solar PV project and a projected risk premium supplied by the single digital token;
storing the project object in the database; and,
responding to queries on the database from actual participants in the solar PV project by returning data in the project object for the solar PV project to the requesting actual participants over the computer communications network.

9. The system of claim 8, wherein the program code is further enabled to perform, associating a developer object in the database with the project object and at least one other project object also stored in the database.

10. The system of claim 8, wherein the program code is further enabled to perform associating a risk portfolio object in the database with the project object and at least one other project object also stored in the database and storing in the risk portfolio object, a risk score value and a risk premium aggregating project risk premium data from each project object associated with the risk portfolio object.

11. The system of claim 7, wherein the program code is further enabled to perform:
receiving from one of the different prospective participants in the infrastructure project, additional information pertaining to implementation of the infrastructure project by the one of the different prospective participants; and,
adding the additional information to the token.

12. The system of claim 7, wherein the program code is further enabled to perform:
loading from the fixed storage, multiple different project objects for correspondingly different infrastructure projects;
identifying amongst the different project objects, common infrastructure assets with similar characteristics;
performing an analytical operation on each of the common infrastructure assets to produce at least one metric pertinent to all of the common infrastructure assets; and,
writing the metric to each of the project objects.

13. A computer program product for managing digital tokens in the common risk management mechanism (CRMM), the computer program product including a non-transitory computer readable storage medium having program instructions embodied therewith, the program instructions executable by a device to cause the device to perform a method including:
receiving from over a computer communications network in memory of a host computing system, data pertaining to a tender offer by a purchasing entity for an infrastructure project;
additionally receiving from over the computer communication network in the memory of the host computing system, data pertaining to a guarantee of required financing for the tender offer including an estimate of a premium for the guarantee, one or more compliance terms for the guarantee and one or more operational parameters of the infrastructure project;
combining the data pertaining to the tender offer with the data pertaining to the guarantee into a single cryptographically encrypted digital token, adapted for decryption with a corresponding decryption key, the token thereby encapsulating information necessary for creation, management, finance, insurance and securitization of one or more infrastructure assets of the infrastructure project;
transmitting the single digital token to the purchasing entity over the computer communications network; and,
subsequently periodically receiving from over the computer communications network, requests to validate the single cryptographically encrypted digital token from different prospective participants in the infrastructure project and upon confirming an authenticity of the signal cryptographically encrypted digital token, replying to each of the requests over the computer communications network with an indication of validation.

14. The computer program product of claim 13, wherein the infrastructure project is a solar photovoltaic (PV) project, and wherein the method further comprises:
modeling the solar PV project as a project object in memory of the host computing system to include a single developer, an estimated capacity of power generation, a distance to a nearest power grid, a contemporaneous state of a workflow for the solar PV project and a projected risk premium supplied by the single cryptographically encrypted digital token;
storing the project object in a database in fixed storage coupled to the host computing system; and,
responding to queries on the database from actual participants in the solar PV project by returning data in the project object for the solar PV project to the requesting actual participants over the computer communications network.

15. The computer program product of claim 14, wherein the method further comprises, associating a developer object in the database with the project object and at least one other project object also stored in the database.

16. The computer program product of claim 14, wherein the method further comprises, associating a risk portfolio object in the database with the project object and at least one other project object also stored in the database and storing in the risk portfolio object, a risk score value and a risk premium aggregating project risk premium data from each project object associated with the risk portfolio object.

17. The computer program product of claim 13, wherein the method further comprises:
receiving from one of the different prospective participants in the infrastructure project, additional information pertaining to implementation of the infrastructure project by the one of the different prospective participants; and,
adding the additional information to the token.

18. The computer program product of claim 13, wherein the method further comprises:
loading from the fixed storage, multiple different project objects for correspondingly different infrastructure projects;
identifying amongst the different project objects, common infrastructure assets with similar characteristics;
performing an analytical operation on each of the common infrastructure assets to produce at least one metric pertinent to all of the common infrastructure assets; and,
writing the metric to each of the project objects.
